(19) United States
(12) Patent Application Publication
(10) Pub. No.: US 2016/0291217 A1
(43) Pub. Date: Oct. 6, 2016

(54) PHANTOM

(71) Applicant: CANON KABUSHIKI KAISHA, Tokyo (JP)

(72) Inventors: Yukio Furukawa, Kyoto-shi (JP); Yasufumi Asao, Kyoto-shi (JP)

(21) Appl. No.: 15/076,837

(22) Filed: Mar. 22, 2016

(30) Foreign Application Priority Data
Apr. 2, 2015 (JP) 2015-076149

(51) Int. Cl. G02B 5/02; G02B 5/00

(52) U.S. Cl. CPC G02B 5/0263; G02B 5/0294; G02B 5/003

(57) ABSTRACT

A phantom used for evaluating an object information acquiring apparatus comprises a first layer irradiated with at least one of light having a first central wavelength based on the optical coherence tomography and light having a second central wavelength based on the photoacoustic tomography, and which has a first scattering region having a first light scattering coefficient, and a second scattering region forming a first pattern with the first scattering region and having a second light scattering coefficient; and a second layer which is integrated with the first layer, and has a first absorption region having a first light absorption coefficient, and a second absorption region forming a second pattern with the first absorption region and having a second light absorption coefficient.

### BACKGROUND OF THE INVENTION

1. Field of the Invention

The present invention relates to a phantom used for the characteristic evaluation of an apparatus that has at least one of an optical coherence tomography function and a photoacoustic tomography function.

2. Description of the Related Art

Optical coherence tomography (OCT) is known as a method for noninvasively acquiring a tomographic image of tissues of a living body such as skin and retina of an eye, and turned into practical use some time ago. In OCT, a light beam two-dimensionally scans the retina using a deflector, and the reflected light and back scattered light are measured, whereby a three-dimensional test image, including information in the invading (vertical) direction acquired by the interferometer, is acquired.

Another known method for noninvasively acquiring a tomographic image is photoacoustic tomography (PAT). In PAT, pulsed light generated from the light source is irradiated to an object, and an acoustic wave generated from tissue absorbing energy of the pulsed light, which is propagated and diffused inside the object, is detected. This phenomena of generating a photoacoustic wave is called a “photoacoustic effect”, and an acoustic wave generated by the photoacoustic effect is called a “photoacoustic wave”. A test segment, such as a tumor and blood vessel, often has high light energy absorptivity with respect to the peripheral tissue, hence such a segment absorbs more light than the peripheral tissue, and instantaneously expands. The photoacoustic wave generated during this expansion is received by a probe, whereby an electric signal is acquired. By mathematically analyzing and processing this electric signal, an image representing the sound pressure distribution of the photoacoustic wave generated inside the object by the photoacoustic effect (hereafter called “PAT image” or “photoacoustic image”) can be acquired. Based on the photoacoustic image acquired in this manner, an optical characteristic distribution inside the object, particularly an optical-absorption coefficient distribution, can be acquired. Information on the optical characteristic distribution inside the object, particularly the optical-absorption coefficient distribution, can also be used for the quantitative measurement of a specific substance in the object such as glucose and hemoglobin contained in blood.

OCT is suited for reconstructing an image of the light scattering distribution, and PAT is suited for reconstructing an image of the light absorption distribution. Simultaneously measuring such different information in a living body has medical significance, and such an object information acquiring apparatus is disclosed in US Patent Application Laid-open No. 2012/0320368. This document discloses that an OCT image is acquired by irradiating light to a measurement target (object), and detecting the back scattered light thereof, and a photoacoustic image is acquired by detecting the photoacoustic wave generated by irradiating light.

To understand a characteristic of an object information acquiring apparatus, a characteristic, such as resolution, of the object information apparatus, is normally evaluated using a structure simulating a living body, which is called a “phantom”. Japanese Patent Application Laid-open No. 2011-235084 discloses an example of a phantom used for OCT.

### SUMMARY OF THE INVENTION

To evaluate a characteristic of an object information acquiring apparatus having both OCT and PAT functions, a characteristic related to the measurement accuracy of OCT is evaluated first using a phantom disclosed in Japanese Patent Application Laid-open No. 2011-235084. Then a characteristic related to the measurement accuracy of PAT is evaluated using a phantom dedicated to the PAT apparatus.

In this case, both characteristics can be detected, but the positions of the phantoms can shift since the phantoms are exchanged for each measurement. As a result, the OCT image and the photoacoustic image cannot be accurately superimposed. Further, in some cases a mechanical error may occur when the OCT apparatus and the PAT apparatus are integrated. This mechanical error becomes one reason why the OCT image and the photoacoustic image cannot be superimposed accurately. Moreover, it is difficult to discern whether the reason why the OCT image and the photoacoustic image cannot be superimposed accurately is due to the above mentioned error, due to the exchange of phantoms or to both. Even if it is known that both error and exchange of phantoms are the cause, the ratio of each factor contributing to the shift of the OCT image and the photoacoustic image cannot be determined. Therefore if characteristics are evaluated using separate phantoms respectively, the accuracy of calibration is still limited because of the above reasons.

With the foregoing in view, it is an object of the present invention to provide a phantom by which an object information acquiring apparatus having at least one of the OCT and PAT functions can be calibrated accurately.

The present invention in its one aspect provides a phantom used for evaluating characteristics of an object information acquiring apparatus that has at least one of an optical coherence tomography function and a photoacoustic tomography function, comprises a first layer which is irradiated with at least one of light having a first central wavelength based on the optical coherence tomography function and light having a second central wavelength based on the photoacoustic tomography function, and which has a first light scattering region having a first light scattering coefficient, and a second light scattering region forming a predetermined first pattern with the first light scattering region and having a second light scattering coefficient that is different from the first light scattering coefficient; and a second layer which is integrated with the first layer, and has a first light absorption region having a first light absorption coefficient, and a second light absorption region forming a predetermined second pattern with the first light absorption region and having a second light absorption coefficient that is different from the first light absorption coefficient.

As mentioned above, according to the present invention, a phantom, by which an object information acquiring apparatus having at least one of the OCT and PAT functions can be calibrated accurately, can be provided.

Further features of the present invention will become apparent from the following description of exemplary embodiments with reference to the attached drawings.

### BRIEF DESCRIPTION OF THE DRAWINGS

FIG. 1 is a cross-sectional view depicting Example 1 of a phantom according to the present invention;

FIG. 2 is a cross-sectional view depicting Example 2 of a phantom according to the present invention;

FIG. 3 is a cross-sectional view depicting Example 3 of a phantom according to the present invention;

FIG. 4 is a block diagram depicting an object information acquiring apparatus according to Example 4 of the present invention;

FIG. 5 is a resolution chart;

FIG. 6 is a flow chart depicting calibration processing in the case of using the phantom of the present invention; and

FIG. 7 is a flow chart depicting the steps after step S13 in flow chart in FIG. 6.

### DESCRIPTION OF THE EMBODIMENTS

Embodiments of the present invention will now be described in detail with reference to the drawings. The same composing elements are denoted with the same reference numbers, and redundant description thereof is omitted. A detailed formula, calculation procedure and the like described herein below should be appropriately changed depending on the configuration and various conditions of the apparatus to which the invention is applied, and are not intended to limit the scope of the invention to the following description.

The object information acquiring apparatus includes an apparatus utilizing the photoacoustic effect, which irradiates light such as near infrared (electromagnetic wave) to an object, receives an acoustic wave generated inside the object thereby, and acquires object information as image data (also called “image signal”).

In the case of the apparatus that utilizes this photoacoustic effect in this way, examples of the object information to be acquired are: a generation source distribution of the acoustic wave generated by irradiating light; an initial sound pressure distribution inside the object; light energy absorption density distribution or absorption coefficient distribution derived from the initial sound pressure distribution; and a concentration distribution of a substance constituting a tissue. The concentration distribution of a substance is, for example, an oxygen saturation degree distribution, a total hemoglobin concentration distribution, and an oxy/deoxy hemoglobin distribution.

The characteristic information, which is object information at a plurality of positions, may be acquired as two-dimensional or three-dimensional characteristic distribution. The characteristic distribution can be generated as image data representing the characteristic information inside the object.

“Acoustic wave” referred to in the present invention is typically an ultrasonic wave, and includes an elastic wave called a “sound wave” and an “ultrasonic wave”. An acoustic wave generated by the photoacoustic effect is called a “photoacoustic wave” or a “light-induced ultrasonic wave”. The acoustic detector (e.g. probe (also called a “transducer”)) receives an acoustic wave generated or reflected inside the object.

Other examples of the object information acquiring apparatus using an optical apparatus are: an anterior camera, a retinal camera, and a scanning laser ophthalmoscope (SLO). An optical coherence tomographic apparatus (optical coherence tomographic meter) based on optical coherence tomography (OCT) utilizing multi-wavelength light wave interference in particular, is an apparatus that can acquire a tomographic image of an object at high resolution.

The optical coherence tomographic apparatus based on OCT is an apparatus that irradiates measurement light, which is low coherent light, to a sample, and measures the back scattered light from the sample using an interference system. The optical coherence tomographic apparatus based on OCT is widely used for ophthalmological diagnosis of the retina or the like, since a tomographic image of a retina to be used for examination can be imaged at high resolution. Furthermore, the OCT apparatus is also widely used for follow-up observation to closely monitor conditions after surgery and progress of an eye disorder.

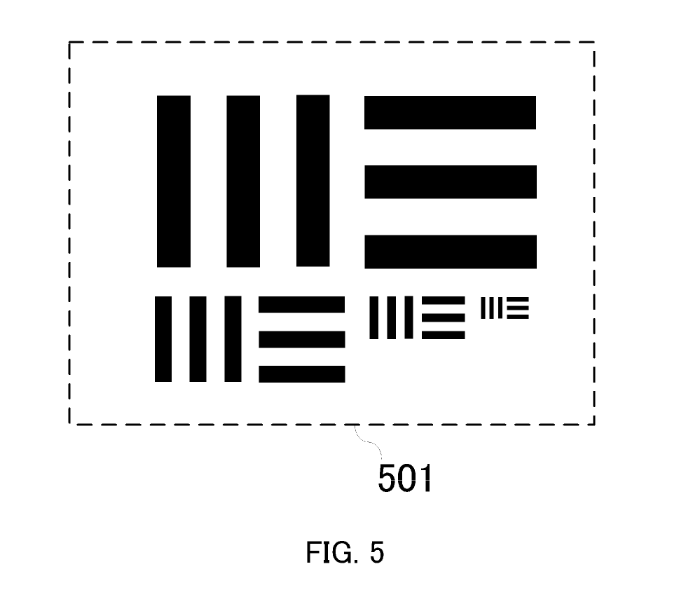

FIG. 5 shows a resolution chart. As a method for evaluating resolution (horizontal resolution) which is a characteristic of an optical system to photograph an image of a two-dimensional surface, such as a camera (characteristic evaluation), the following is known. For example, a resolution chart 501 having a pattern shown in FIG. 5 is photographed. Then brightness corresponding to the density is measured. Thereby the modulation transfer function (MTF) and the Contrast Transfer Function (CTF) are calculated to evaluate the resolution of the system. The present invention is not limited to this, and contrast may be evaluated instead of brightness.

The resolution chart normally has a pattern that changes from low frequency to high frequency exceeding the resolution of the system that is theoretically acquired from an original design. The density (brightness) of the pattern includes zero (white), maximum density (black), a combination of zero and half tone (gray), a combination of half tone and maximum density and the like, corresponding to each case of having a different gradation in each density range (brightness).

### Example 1

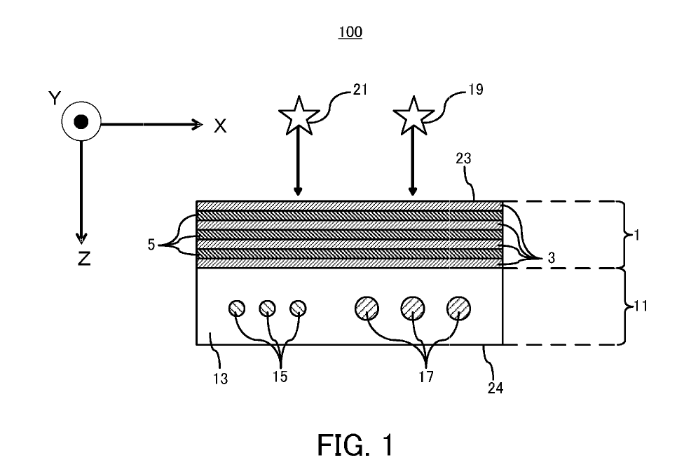

FIG. 1 is a cross-sectional view depicting Example 1 of the phantom according to the embodiment of the present invention. The phantom 100 of Example 1 is basically constituted by a structure 1 for evaluating the resolution of OCT (hereafter “structure 1”), and a structure 11 for evaluating resolution of PAT (hereafter “structure 11”). An irradiation light 21 for OCT (hereafter “light 21”) and an irradiation light 19 for PAT (hereafter “light 19”) are irradiated to the principal plane 23 of the phantom 100 in the arrow direction (Z direction) in FIG. 1. The Z direction is the thickness direction of the phantom, which is the same for the other examples.

The configuration of the structure 1, which is the first layer, will be described first. The brightness of an image acquired by OCT increases as the intensity of the reflected light and the back scattered light based on the light 21 inside the phantom 100 increases. Therefore the image acquired by OCT has a brightness that has a non-zero value when light scattering bodies exist in a predetermined region of the object at an appropriate concentration. In the structure 1, a light scattering region 3, of which light scattering coefficient is relatively small, and a light scattering region 5, of which light scattering coefficient is relatively large, are alternately laminated in the Z axis direction. Thereby the tomographic image in the Z direction as shown in the resolution chart in FIG. 5 can be acquired.

The light scattering region 3 has a structure where first particles are dispersed in a first transparent medium at a desired concentration, and the light scattering region 5 has a structure where second particles are dispersed in a second transparent medium at a desired concentration. The first and second transparent media have a 90% or higher transmittance with respect to the central wavelength λ_{OCT} of the light 21 and the central wavelength λ_{PAT} of the light 19 respectively. The light scattering regions 3 and 5 are formed respectively by preparing photo curing material (e.g. by UV curing resin), dispersing particles having different refractive indexes from the photo curing material, forming a thin film thereby, and then curing the film. The light scattering regions 3 and 5 may be formed using a dispersant, so that the first and second particles do not aggregate or precipitate.

It is preferable that the particle diameters of the first and second particles are the central wavelength λ_{OCT} or more, and smaller than the thickness of the light scattering regions 3 and 5. If the particle diameters of the first and second particles are considerably smaller than the central wavelength λ_{OCT} of the light 21, scattering is not generated at a desired intensity, and if larger than the thickness of the light scattering regions 3 and 5, then the boundary of the layers does not become a uniform plane (or curved surface). The materials of the first and second particles have refractive indexes which are different from those of the first and second transparent media, and may be latex, silica particles, titanium oxide particles or the like. At least either particle sizes or the materials (refractive indexes) of the first and second particles may be the same, or may be different according to the characteristic of an actual skin cell or the like.

If the concentration of the first and second particles is too low, the S/N of the image to be acquired deteriorates, and if too high, the invasion depth of the light 21 drops. The particle diameters of the first and second particles influence the signal intensity of the image signal acquired by OCT. Therefore it is preferable that the concentration of the first and second particles is adjusted such that the signal intensity of the image signal acquired upon observing actual skin and the signal intensity of the image signal acquired by measuring the phantom 100 by OCT become approximately the same. The particle concentration of the light scattering region 3 may be controlled to zero in order to evaluate the resolution in the case when contrast is the maximum. In this case, the light transmittance in the light scattering region 3 becomes 90% or more.

The intensity of the reflected light, which is reflected on the boundary surface between the light scattering region 3 and the light scattering region 5, becomes too strong if the reflectance of light on this boundary surface is too high. As a result, an image of the area around the boundary surface cannot be clearly reconstructed. In this case, the first and second transparent media should be constructed in the same way, so that the difference between the refractive index of the first transparent medium and the refractive index of the second transparent medium (refractive index difference) becomes close to zero. Then the reflection of the light on the boundary surface can be decreased. This is because the reflection of light is mainly generated based on the difference of the refractive indexes. The composition and size of the first particles may be different from those of the second particles. In this case, the first and second particles may be different particles according to the difference of the molecular structure of the first and second transparent media, so that the first and second particles can be dispersed well in the first and second transparent media. In this case, in order to minimize the reflectance on the boundary surface between the light scattering region 3 and the light scattering region 5, it is preferable to select the first and second particles as follows. It is preferable to select the materials of the first and second transparent media so that the difference between the refractive index n₁ of the light scattering region 3 and the refractive index n₂ of the light scattering region 5 is minimized. The intensity of the reflected light or the back scattered light propagated from the light scattering regions 3 and 5 based on the light 21 preferably has a value similar to the intensity of the reflected light or the back scattered light propagated when the light 21 is irradiated to human skin. In other words, it is preferable that the concentration values of the first and second particles satisfy this condition. The value of (intensity of reflected light or back scattered light)/(intensity of light 21) becomes about 10⁻⁵ if the concentration values of the first and second particles are set to satisfy the above conditions. Therefore it is preferable that the reflectance on the boundary surface between the light scattering region 3 and the light scattering region 5 is smaller than this value 10⁻⁵. This means that the materials of the first and second transparent media are preferably selected so as to satisfy the following Expression (1),

{(n₁−n₂)/(n₁+n₂)}²≦0.00001 (1)

where n₁ denotes the refractive index n₁ of the light scattering region 3, and n₂ denotes the refractive index n₂ of the light scattering region 5. In other words, the first and second transparent media may be constituted by materials of which refractive index difference thereof (|n₁−n₂|) becomes 0.63% or less. In the reconstructed image by OCT acquired in this manner, the negative influence by regular reflected light on the boundary surface between the light scattering region 3 and the light scattering region 5 has been reduced, and noise components have been decreased. This is because the reconstructed image by OCT acquired in this manner has been generated only by the back scattered light from each light scattering region.

Materials of the transparent medium forming the light scattering region 3 and the transparent medium forming the light absorption region 13 may be selected so as to satisfy the following Expression (2),

{(n₁−n₃)/(n₁+n₃)}²≦0.00001 (2)

where n₁ denotes the refractive index n₁ of the light scattering region 3, and n₃ denotes the refractive index n₃ of the light absorption region 13.

Materials of the transparent medium forming the light scattering region 5 and the transparent medium forming the light absorption region 13 may be selected so as to satisfy the following Expression (3),

{(n³−n²)/(n³+n²)}²≦0.00001 (3)

where n₂ denotes the refractive index n₂ of the light scattering region 5, and n₃ denotes the refractive index n₃ of the light absorption region 13.

The configuration of the structure 11, which is the second layer, will be described next. To evaluate resolution, which is one measurement accuracy indicator, in PAT measurement, the light 19 is irradiated to the light irradiation surface 23 of the phantom 100, which is the light irradiation surface 23 of the structure 1. The light 19 transmits through the structure 1 and reaches the structure 11. In the structure 11, the reached light 19 is absorbed by the light absorption regions 15 and 17, and the light absorption regions 15 and 17 thermally expand, whereby an acoustic wave is generated. This acoustic wave may be reflected on the boundary surface between the light scattering region 3 and the light scattering region 5. This reflection of the acoustic wave drops the intensity of the acoustic wave received by the transducer, or generates a ghost image on the photoacoustic image acquired by image reconstruction due to multiple reflection. Therefore it is preferable that the acoustic impedance values of the light scattering region 3 and the light scattering region 5 are equal. Further, the reflectance of the acoustic wave on the boundary surface between the light scattering region 3 and the light scattering region 5 may be set to 5% or less. Then the influence of the reflection of the acoustic wave on the photoacoustic image can be substantially ignored. Here the average acoustic impedance, considering the volume of the first transparent member and the first particles, that is the acoustic impedance of the light scattering region 3, is defined as acoustic impedance Z₁. An average acoustic impedance, considering the volume of the second transparent member and the second particles, that is the acoustic impedance of the light scattering region 5, is defined as acoustic impedance Z₂. For acoustic impedance values Z₁ and Z₂, it is preferable that the materials of the first and second transparent members and particles are selected so as to satisfy the following Expression (4),

|(Z₁−Z₂)/(Z₁+Z₂)|≦0.05 (4)

where Z₁ and Z₂ denotes acoustic impedance values Z₁ and Z₂. Thereby negative influence of the reflection of the acoustic wave in the structure 1 on the photoacoustic image can be reduced.

The brightness of a photoacoustic image acquired in the photoacoustic measurement by the object information acquiring apparatus is higher as the light absorption coefficient of a light absorption region existing inside the object (phantom 100 in this case) is larger. The photoacoustic measurement is also called “photoacoustic tomography (PAT) measurement”. The brightness of a photoacoustic image has a certain value when a light absorption region, having an appropriate concentration of light absorbers, exists in a region to be imaged (region of interest) inside the phantom 100. The light absorbers are distributed inside the structure 11 having a known regular pattern. Thereby a tomographic image corresponding to the resolution chart shown in FIG. 5 can be acquired. Therefore in the structure 11, the light absorption regions 15 and 17 having appropriate concentration are embedded in a pattern known in advance. The structure 11 is constituted by a light absorption region 13 having a small light absorption coefficient, and a light absorption region 15 and a light absorption region 17 having large light absorption coefficients. The light absorption regions 15 and 17 may both be spheres, and in this case, the shapes thereof in the tomographic image corresponding to the resolution chart are both approximately disk shapes. The light absorption regions 15 and 17 may both be cylindrical shapes, and in this case, the shapes thereof in the tomographic image corresponding to the resolution chart are approximately rectangular shapes, of which short side is in the X direction and the long side is in the Y direction. In FIG. 1, three light absorption regions 15 are disposed at approximately equal intervals along the X direction, which is one principal plane direction of the phantom 100 (direction approximately orthogonal to the thickness direction of the phantom 100). This is the same for the light absorption regions 17. The principal plane 23 of the phantom 100 is a light irradiation surface where the normal line direction is the Z direction. The rear surface 24 of the phantom 100 is a plane approximately parallel with the principal plane 23. A number of the light absorption regions 15 disposed here is three, but the number may be one, two or more.

The light absorption region 13 is constituted by a third transparent medium in which first light absorbers are dispersed at a desired concentration. The light absorption region 15 and the light absorption region 17 are constituted by a fourth transparent medium in which second light absorbers are dispersed at a desired concentration and are different from each other in size. For light 19 to reach the light absorption regions 15 and 17 more uniformly, it is preferable to form the light absorption region 13 by dispersing third particles at an appropriate concentration. The third and fourth transparent media have transmittance that is 90% or more with respect to the central wavelength λ_{PAT} of the light source used for the photoacoustic measurement. Here the light absorption regions 13, 15 and 17 are formed by dispersing light absorbers (e.g. dyes) and particles in a photo curing material, such as UV curing resin (third and fourth transparent media), of which refractive index is different from the particles, and then curing this photo curing material. In this case, dispersant may be used for the light absorption regions 13, 15 and 17, so that the light absorbers and the particles do not aggregate or precipitate. Besides the UV curing resin, the third and fourth transparent media are constituted by urethane, PVA (polyvinyl alcohol) or the like. The particles dispersed in the third and fourth transparent media are constituted by, for example, latex, silica particles, titanium oxide particles or the like. The light absorption regions 15 and 17 may be formed so as to be embedded in the light absorption region 13.

If the concentration of the light absorbers in the light absorption regions 15 and 17 are too low, the S/N of the image to be acquired deteriorates, and if the concentration of the light absorbers in the light absorption region 13 is too high, the invasion depth of the light 19 drops. Therefore it is preferable to adjust these concentration values such that the signal intensity of the reconstructed image signal that is acquired when actual human skin is measured by photoacoustic measurement, and the signal intensity of the image signal acquired by measuring the phantom 100 by photoacoustic measurement, become approximately the same. In this case, the light absorption coefficient of the light absorption region 13 may be adjusted to be similar to the light absorption coefficient of a fat layer of a living body, and the light absorption coefficients of the light absorption regions 15 and 17 may be adjusted to be similar to the light absorption coefficient of the blood of a living body. The concentration of the light absorbers in the light absorption region 13 may be set to virtually zero. In this case, the transmittance of the light 19 in the light absorption region 13 becomes 90% or more. The phantom created in this manner can evaluate resolution (characteristic) when the contrast is at the maximum.

The boundary surface formed by contact of the structure 1 and the structure 11 may reflect the light 21 in some cases, and the reflected light at this time influence the OCT image negatively. Further, this boundary surface may also reflect an acoustic wave generated during the photoacoustic measurement in some cases, and the acoustic wave reflected at this time influence the photoacoustic image negatively. Therefore it is preferable to select material of the third transparent medium and the first transparent medium constituting the light absorption region 13 to satisfy the following Expression (5),

{(n₁−n₃)/(n₁+n₃)}²≦0.00001 (5)

where n₁ denotes a refractive index n₁ of the first transparent medium, and n₃ denotes a refractive index n₃ of the third transparent medium. The materials of the third transparent medium and the first transparent medium may also be selected such that the refractive index n₁ and the refractive index n₃ become approximately the same.

The acoustic impedance Z₃ of the light absorption region 13 may be approximately the same as the acoustic impedance Z₁ of the light scattering region 3. Otherwise the following Expression (6) may be satisfied,

|(z₁−z₃)/(z₁+Z₃)|≦0.05 (6)

where Z₁ denotes the acoustic impedance Z₁ of the light scattering region 3, and Z₃ denotes the acoustic impedance Z₃ of the light absorption region 13. Thereby the reflection of the acoustic wave on the boundary surface can be prevented, and a negative influence of the reflected acoustic wave on the photoacoustic image can be reduced.

The present invention is not limited to this, and the same concept can be applied to the case when the light scattering region 5 and the light absorption region 13 are laminated to contact each other. In other words, the acoustic impedance Z₃ of the light absorption region 13 may be approximately the same as the acoustic impedance Z₂ of the light scattering region 5. Otherwise the following Expression (7) may be satisfied,

|(z₂−Z₃)/(Z₂+Z₃)|≦0.05 (7)

where Z₂ denotes the acoustic impedance Z₂ of the light scattering region 5, and Z₃ denotes the acoustic impedance Z₃ of the light absorption region 13. Thereby the reflection of the acoustic wave on the boundary surface between the light scattering region 5 and the light absorption region 13 can be prevented, and the negative influence of the reflected acoustic wave on the photoacoustic image can be reduced.

A difference of the light scattering coefficients between the light scattering region 3 and the light absorption region 13, that exceeds a certain value, causes the appearance of an image due to the boundary surface of the structure 1 and the structure 11 in the OCT image. This difference should be set to a certain value or more if the image, due to the boundary surface, is displayed intentionally. If the image, due to the boundary surface, is not display intentionally, on the other hand, this difference may be set to virtually zero.

If the phantom 100 configured as above is used, a phantom need not be exchanged when OCT measurement and PAT measurement are performed. Therefore, when an OCT image and a PAT image acquired by measuring the phantom 100 by OCT and PAT cannot be superimposed accurately, the cause of this is limited to a mechanical error, which was generated when the OCT apparatus and the PAT apparatus are integrated. This means that an object information acquiring apparatus having the OCT and PAT functions can be calibrated by performing mechanical or software-based adjustment on this object information acquiring apparatus. The present invention is not limited to this, and the phantom of the present invention can also be used for calibrating an object information acquiring apparatus having an OCT or PAT function alone.

By performing the OCT measurement and the PAT measurement using the phantom 100 configured as above, the resolution of the object information acquiring apparatus in the vertical direction (Z direction) for the OCT measurement and in the horizontal direction (X direction) for the PAT measurement can be measured without causing a positional shift of the phantom 100. Therefore mechanical or software-based adjustment can be performed on the object information acquiring apparatus. This means that an object information acquiring apparatus which has at least one of the OCT function and the PAT function can be calibrated accurately for both resolution in the vertical direction (Z direction) for the OCT measurement, and resolution in the horizontal direction (X direction) for the PAT measurement.

### Example 2

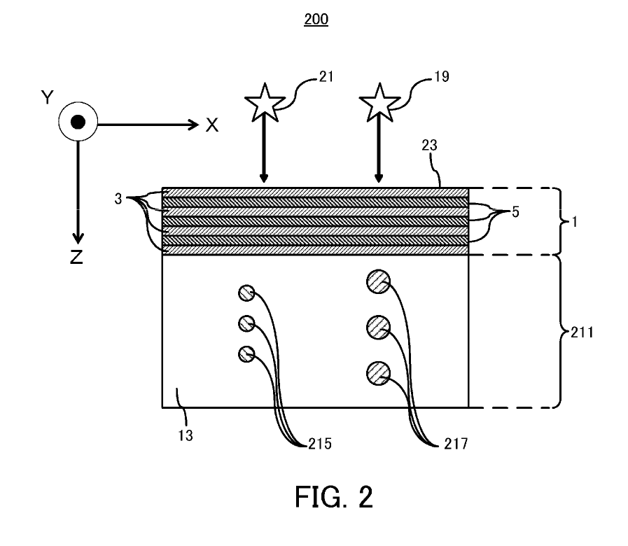

FIG. 2 is a cross-sectional view depicting Example 2 of the phantom according to the embodiment of the present invention. A same composing element as FIG. 1 is denoted with a same number, and description thereof is omitted. A composing element similar to Example 1 is denoted with a number in the 200 series having the same numbers as Example 1 in the second and third digits, and description thereof is omitted unless necessary. The difference between the phantom 200 of Example 2 and phantom 100 of Example 1, out of the functions of the object information acquiring apparatus, is that a structure 211 for evaluating the resolution of the PAT function is configured such that the resolution in the vertical direction (Z direction) can be measured. The phantom 200 is constituted by a structure 1 for evaluating the resolution of the OCT function, and a structure 211 for evaluating the resolution of the PAT function, which are laminated. The structure 211 has light absorption regions 215 and light absorption regions 217 in a light absorption region 13. The light absorption regions 215 are disposed in the Z direction at equal intervals. The light absorption regions 217 are also disposed in the same manner. The arrangement of these light absorption regions 215 and 217 is different from that of the light absorption regions 15 and 17 in Example 1. The composition of the light absorption regions 215 and the composition of the light absorption regions 217 are the same as those of the light absorption regions 15 and 17 respectively.

The light 19 and light 21 are irradiated in the Z direction toward the principal plane 23 of the phantom 200, that is, toward the principal plane 23 of the structure 1, as in Example 1.

Using the phantom 200 configured as above, the resolution in the vertical direction (Z direction) of the OCT function and the resolution in the vertical direction (Z direction) of the PAT function are measured. By using these measurement results, the resolution in the vertical direction (Z direction) of the OCT function and the resolution in the vertical direction (Z direction) of the PAT function can be calibrated accurately for an object information acquiring apparatus which has at least one of the OCT function and the PAT function. A concrete calibration method thereof will be described in Example 4.

### Example 3

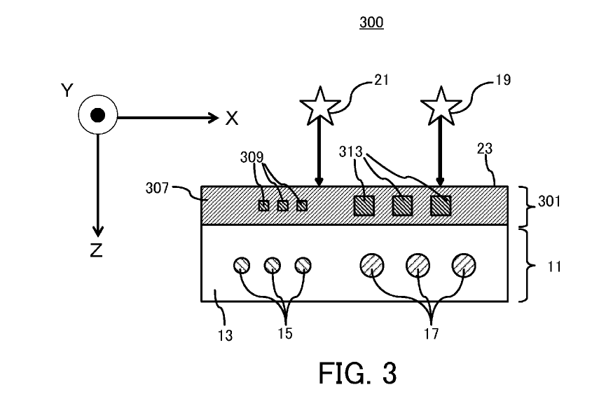

FIG. 3 is a cross-sectional view depicting Example 3 of the phantom according to the embodiment of the present invention, where a same composing element as FIG. 1 is denoted with a same number, and description thereof is omitted. A composing element similar to Example 1 is denoted with a number in the 300 series having the same numbers as Example 1 in the second and third digits, and description thereof is omitted unless necessary. The difference between the phantom 300 of Example 3 and the phantom 100 of Example 1, out of the functions of the object information acquiring apparatus, is that a structure 301 for evaluating the resolution of the OCT function is configured such that the resolution in the horizontal direction (X direction) can be measured. The phantom 300 is constituted by a structure 301 for evaluating the resolution of the OCT function and a structure 11 for evaluating the resolution of the PAT function, which are laminated. The structure 301 has light scattering regions 307, 309 and 313.

The light scattering regions 309 are disposed in the X direction at equal intervals. “Interval” here refers to a distance between the light scattering regions 309. The light scattering regions 313 are also disposed in the same manner. The arrangement of these light scattering regions 309 and 313 is different from that of the light scattering regions 3 and 5 in Example 1. The composition of the light scattering region 307 is the same as that of the light scattering region 3 of Example 1. The composition of the light scattering region 309 and that of the light scattering region 313 are the same as that of the light scattering region 5 of Example 1. The light scattering regions 309 and 313 may be embedded in the light scattering region 307. However, the present invention is not limited this, and each composition may be changed appropriately according to the measurement requirement.

The light 19 and light 21 are irradiated toward the principal plane 23 of the phantom 300, that is, toward the principal plane 23 of the structure 301, as in Example 1.

Using the phantom 300 configured as above, the resolution in the horizontal direction (X direction( ) of the OCT function and the resolution in the horizontal direction (X direction) of the PAT function are measured. By using this measurement results, the resolution in the horizontal direction (X direction) of the OCT function and the resolution in the horizontal direction (X direction) of the PAT function can be calibrated accurately for an object information acquiring apparatus which has at least one of the OCT function and the PAT function. A concrete calibration method thereof will be described in Example 4.

The phantoms 100, 200 and 300 of Example 1, 2 and 3 have structures suitable for evaluating the resolution of an object information acquiring apparatus having at least one of the OCT function and the PAT function. However, the present invention is not limited to this, and a phantom that can evaluate the S/N of the OCT function can be constructed by disposing, for example, a plurality of layers, of which concentration values of the particles for light scattering are different from one another. Further, a phantom that can evaluate the S/N of the PAT function can be constructed by disposing a plurality of regions, of which concentration values of the light absorbers are different from one another.

Here the structure for evaluating the measurement accuracy (resolution in this case) of OCT measurement is disposed on one side where the light of the phantom is irradiated. This is because the invasion depth of the light 19 used for the photoacoustic measurement into the object is deeper than the invasion depth of the light 21 used for the OCT measurement. Further, the structure for evaluating the measurement accuracy of the PAT measurement is disposed on the rear surface side of the structure for evaluating the measurement accuracy of the OCT measurement, that is, on the opposite side of the light irradiation side. Each phantom is constituted by the structure for evaluating the measurement accuracy of the OCT measurement and the structure for evaluating the measurement accuracy of the PAT measurement, which are laminated in the Z direction in FIGS. 1, 2 and 3. But the present invention is not limited to this, and the light absorption regions for evaluating the measurement accuracy of the PAT measurement may be embedded in the structure for evaluating the measurement accuracy of the OCT measurement. The phantom may be a single structure having a single region where the light 19 is absorbed and the light 21 is scattered.

### Example 4

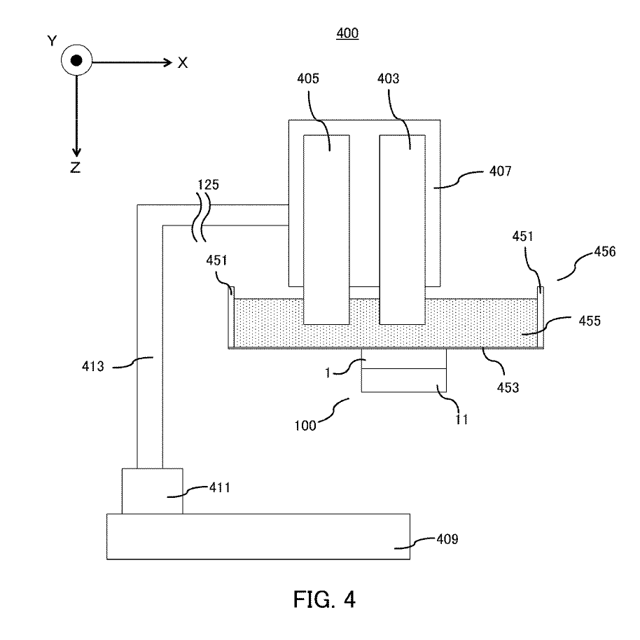

FIG. 4 is a block diagram depicting Example 4 of the object information acquiring apparatus according to the embodiment of the present invention, where a same composing element as FIG. 1 is denoted with a same number, and description thereof is omitted. The object information acquiring apparatus 400 of this example (hereafter called “apparatus 400”) has an apparatus 403 that performs an OCT function, an apparatus 405 that performs a PAT function, and a case body 407 that integrates and houses the apparatus 403 and the apparatus 405. The apparatus 400 also has an X axis stage 409 that can move the case body 407 in the X direction, a Y axis stage 411 that can move the case body 407 in the Y direction, and a support 413 that connects the X axis stage 409, the Y axis stage 411 and the case body 407. By this configuration, the apparatus 403 and the apparatus 405 can two-dimensionally move along the XY plane using the X axis stage 409 and the Y axis stage 411.

The matching solution 455 fills the space between the phantom 100 of Example 1 and the apparatuses 403 and 405. The matching solution 455 is a liquid that can propagate light and acoustic waves between the apparatuses 403 and 405 and the phantom 100, and is water, for example. A container 456 is constituted by side walls 451 and a thin film 453, and holds the matching solution 455 in the space created by the side walls 451 and the thin film 453. The thin film 453 is constituted by a material which propagates light and acoustic waves. The present invention however is not limited to this, and the container for holding the matching solution 455 may have a shape where the side walls 451 (side part) and the thin film 453 (base part) cannot be clearly separated, such as a bowl shape.

The apparatus 403 irradiates light, of which central wavelength is set to 850 nm, toward the phantom 100. The half width of the wavelength spectrum of this light is set to 50 nm. In this case, the half width of the coherence function determined by calculation is approximately 6 μm. Therefore the layer thickness of each layer of the structure 1 used for evaluating the measurement accuracy (resolution in this case) of the OCT measurement are all set to 6 μm.

The apparatus 405 has a focus type transducer of which central frequency to receive the acoustic wave from the phantom 100 is 50 MHz. In this case, the resolution of the apparatus 405 is approximately 50 μm in the horizontal direction (X direction), and 30 μm in the vertical direction (Z direction), although this depends on the focal length. Therefore the intervals of the light absorption regions disposed in the structure 11 used for evaluating the measurement accuracy of the PAT measurement are set to intervals which allow evaluating the measurement accuracy (resolution in this case) of the OCT measurement and the PAT measurement.

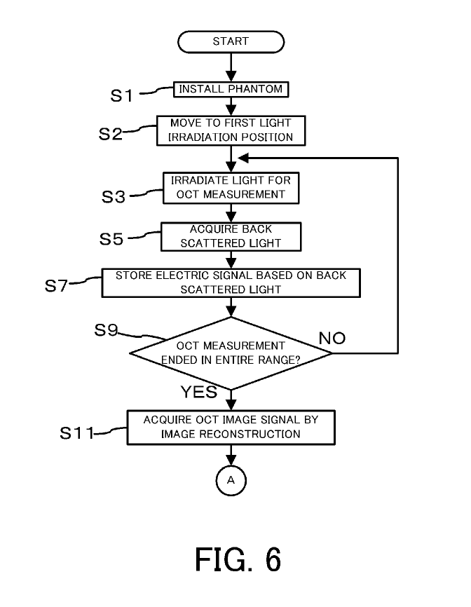

FIG. 6 is a flow chart depicting the calibration processing of the object information acquiring apparatus 400 according to Example 4 of the present invention, in the case of using the phantom 100 according to Example 1 of the invention for the calibration processing. The flow starts when power is supplied to the apparatus 400.

In step S1, the phantom 100 is installed on an object stand, which is disposed in the apparatus 400, and processing advances to step S2. In step S2, the light emission end of the apparatus 403 moves to a light irradiation position from which light is initially irradiated to the phantom 100, and processing advances to step S3. In step S3, the light for OCT is irradiated from the light irradiation position, to which the light emission end of the apparatus 403 moved, toward the surface of the phantom 100. By this light irradiation, a back scattered light is generated from the light scattering regions 3 and 5 of the phantom 100, and processing advances to step S5. In step S5, this back scattered light is converted into an electric signal by a photoelectric conversion element or the like, and is outputted, and processing advances to step S7. In this case, a photoelectric conversion circuit, constituted by a photodiode or the like, may be used for the photoelectric conversion element. In step S7, this electric signal is converted from an analog to a digital signal by an analog/digital conversion circuit, and the digital signal generated by this conversion is stored in a memory or the like disposed in the apparatus 400 in advance, and processing advances to step S9. Various memories can be used for this memory, such as EEPROM, SRAM, DRAM, external memory or an internal memory of the apparatus 400.

In step S9, it is determined whether this storage processing to the memory has been performed for all the light irradiation positions. If it is determined that the storage processing to the memory has not been performed for all the light irradiation positions, the apparatus 403 moves to the next light irradiation position, and processing returns to step S3. If it is determined that the storage processing to the memory has been performed for all the light irradiation positions, on the other hand, processing advances to step S11. In step S11, the digital signal stored in the memory is read. By performing image reconstruction based on the read digital signal, the OCT image signal is acquired, and processing advances to step S13. The “image signal” is for displaying an image on a display or the like, and has the same meaning as “image data”.

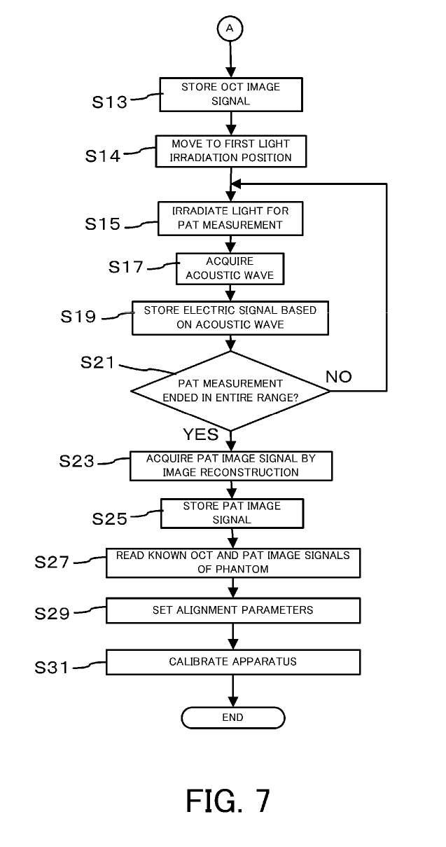

FIG. 7 is a flow chart depicting the processing in the steps after step S11 in the flow chart of FIG. 6. In step S13, the acquired OCT image signal is stored in a memory disposed in the apparatus 400, and processing advances to step S14. In step S14, the light emission end of the apparatus 405 moves to a light irradiation position from which light is initially irradiated to the phantom 100, and processing advances to step S15. In step S15, the light for PAT is irradiated from the light irradiation position, to which the light emission end of the apparatus 405 moved, toward the surface of the phantom 100. By this light irradiation, an acoustic wave is generated from the light absorption regions 15 and 17 of the phantom 100, and processing advances to step S17. In step S17, this acoustic wave is converted into an electric signal by the transducer or the like, and is outputted, and processing advances to step S19. In this case, the transducer may be constituted by an oscillator using piezoelectric ceramics (lead zirconate titanium: PZT). The transducer may be constituted by a capacitance type capacitive micro-machined ultrasonic transducer (CMUT) or a Magnetic MUT (MMUT) using a magnetic film. The transducer may also be constituted by a Piezoelectric MUT (PMUT) that uses piezoelectric thin film. In step S19, this electric signal is converted from an analog to a digital signal by an analog/digital conversion circuit, and the digital signal generated by this conversion is stored in a memory or the like disposed in the apparatus 400 in advance, and processing advances to step S21.

In step S21, it is determined whether this storage processing to the memory has been performed for all the light irradiation positions in the phantom 100. If it is determined that the storage processing to the memory has not been performed for all the light irradiation positions, the apparatus 405 moves to the next light irradiation position, and processing returns to step S15. If it is determined that the storage processing to the memory has been performed for all the light irradiation positions, on the other hand, processing advances to step S23. In step S23, the digital signal stored in the memory is read. By performing the image reconstruction based on the read digital signal, the PAT image signal is acquired, and processing advances to step S25. In step S25, the acquired PAT image signal is stored in a memory disposed in the apparatus 400, and processing advances to step S27.

In step S27, ideal image signal, when an image is constructed after measuring the phantom 100 by PAT and OCT, are read to the apparatus 400, and processing advances to step S29. The ideal image signals may be stored in the apparatus 400 in advance, or may be appropriately inputted by the user. The ideal image signals are provided for PAT and OCT respectively. In step S29, parameters for aligning the OCT image signal and the PAT image signal acquired by the processing thus far are set based on the read ideal image signals, and processing advances to step S31. These parameters are, for example, shift correction values when the dimensions of the case body 407 are shifted from the design values. In step S31, mechanical or software-based adjustment is performed for each configuration of the apparatus 400 based on the parameters that are set in step S29, whereby the apparatus 400 is calibrated and the processing flow ends. The mechanical or software-based adjustment method used in step S31 here may be the following method, for example. Each configuration of the apparatus 400 (parameters of each part and software of the apparatus 400) is adjusted. Then the PAT and OCT measurement are performed again. Next the image signals are acquired and compared with the ideal image signals. The series of processes from the adjustment to the comparison is repeated until the comparison result falls within a predetermined allowable range. These processes may be manually performed by the user, or may be automatically performed by the apparatus 400.

If the phantom 100 configured as above is used, the phantom need not be exchanged for the OCT measurement and PAT measurement. Therefore when an OCT image and a PAT image acquired by measuring the phantom 100 by OCT and PAT cannot be superimposed accurately, the cause of this is limited to a mechanical error, which was generated when the OCT apparatus and the PAT apparatus are integrated. This means that an object information acquiring apparatus having the OCT and PAT functions can be calibrated by performing mechanical or software-based adjustment on this object information acquiring apparatus. The other phantoms described in the other examples can also be used in the same manner.

Embodiments of the various characteristics of the present invention are not limited to the examples described above. For example, the first layer of the phantom according to one example may be changed to the first layer of another example, and the second layer of one example may be changed in the same manner. Further, the light absorption regions 17 of Example 1 may be disposed at approximately equal intervals in the Z direction. Then resolution in the X direction and the resolution in the Y direction based on the PAT function can be calibrated. Furthermore, the light scattering regions 309 of Example 3 may be disposed at approximately equal intervals in the Z direction. Then resolution in the X direction and the resolution in the Y direction based on the OCT function can be calibrated.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-076149, filed on Apr. 2, 2015, which is hereby incorporated by reference herein in its entirety.

1. A phantom used for evaluating characteristics of an object information acquiring apparatus that has at least one of an optical coherence tomography function and a photoacoustic tomography function, comprising:
a first layer which is irradiated with at least one of light having a first central wavelength based on the optical coherence tomography function and light having a second central wavelength based on the photoacoustic tomography function, and which has a first light scattering region having a first light scattering coefficient, and a second light scattering region forming a predetermined first pattern with the first light scattering region and having a second light scattering coefficient that is different from the first light scattering coefficient; and
a second layer which is integrated with the first layer, and has a first light absorption region having a first light absorption coefficient, and a second light absorption region forming a predetermined second pattern with the first light absorption region and having a second light absorption coefficient that is different from the first light absorption coefficient.

2. The phantom according to claim 1, wherein a light scattering coefficient of the second light absorption region is approximately the same as the light scattering coefficient of the first light scattering region.

3. The phantom according to claim 1, wherein the first layer is formed by laminating the first light scattering region and the second light scattering region.

4. The phantom according to claim 1, wherein the second light scattering region is embedded in the first light scattering region.

5. The phantom according to claim 1, wherein the second light absorption region is embedded in the first light absorption region.

6. The phantom according to claim 4, wherein a plurality of the second light scattering regions are disposed approximately at equal intervals in a direction approximately orthogonal to a thickness direction of the first layer.

7. The phantom according to claim 1, wherein a plurality of the second light absorption regions are disposed approximately at equal intervals in a direction approximately orthogonal to a thickness direction of the second layer.

8. The phantom according to claim 1, wherein a plurality of the second light absorption regions are disposed approximately at equal intervals along a thickness direction of the second layer.

9. The phantom according to claim 1, wherein
the first light scattering region is in contact with the first light absorption region, and
when Z₁ denotes an acoustic impedance of the first light scattering region, and Z₃ denotes an acoustic impedance of the first light absorption region, Z₁ and Z₃ satisfy |(Z₁−Z₃)/(Z₁+Z₃)|≦0.05.

10. The phantom according to claim 3, wherein when Z₁ and Z₂ denote acoustic impedances of the first and second light scattering regions respectively, Z₁ and Z₂ satisfy |(Z₁−Z₂)/(Z₁+Z₂)|≦0.05.

11. The phantom according to claim 1, wherein
the first light scattering region is in contact with the first light absorption region, and
when n₁ and n₃ denote a refractive index of the first light scattering region and a refractive index of the first light absorption region respectively, n₁ and n₃ satisfy {(n₁−n₃)/(n₁+n₃)}²≦0.00001.

12. The phantom according to claim 3, wherein when n₁ and n₂ are refractive indexes of the first and second light scattering regions respectively, n₁ and n₂ satisfy {(n₁−n₂)/(n₁+n₂)}²≦0.00001.
